(19) United States
(12) Patent Application Publication
(10) Pub. No.: US 2026/0368230 A1
(43) Pub. Date: Nov. 19, 2026

(54) INTENT-SYNTHESIZED BIDIRECTIONAL EMBEDDING SEARCHES

(71) Applicant: Contentful GmbH, Berlin (DE)

(72) Inventors: Jason Jay McGHEE, Walnut Creek, CA (US); Adam WEINSTEIN, Carmel, IN (US)

(21) Appl. No.: 19/669,115

(22) Filed: May 6, 2026

Related U.S. Application Data
(60) Provisional application No. 63/806,345, filed on May 15, 2025.

(51) Int. Cl. G06F 16/334; G06F 16/338

(52) U.S. Cl. CPC G06F 16/3347; G06F 16/338

(57) ABSTRACT

The systems and methods disclosed herein execute intent-synthesized bidirectional embedding searches. A query is received from a user interface. The systems and methods generate/determine (e.g., via an AI model and/or user input) a label for the query and construct a training dataset of synthetic artifacts (e.g., results, data). A linear model is trained using the training dataset to determine a vector representation of the expected output of the query. Thus, the linear model can be used to select non-synthetic artifacts (e.g., data) from a vector database based on a similarity between the vector representations of each non-synthetic artifact and the expected output. Thus, when a new artifact is added, matching queries can be identified based on a similarity between the vector representations of the new artifact and the queries.

### CLAIM OF PRIORITY

This application claims benefit of and priority, under 35 U.S.C. §119(e), to U.S. Provisional Patent Application No. 63/806,345, filed on May 15, 2025, and titled “INTENT-SYNTHESIZED BIDIRECTIONAL EMBEDDING SEARCHES”, which is incorporated by reference herein in its entirety.

### TECHNICAL FIELD

The present disclosure is related to artificial intelligence (AI), and more particularly to AI-driven bidirectional embedding searches that are synthesized based on intent of a query.

### BACKGROUND

Artificial intelligence (AI) models often operate based on extensive and enormous training models. The models include a multiplicity of inputs and how each should be handled. When the model receives a new input, the model produces an output based on patterns determined from the data the model was trained on. A large language model (LLM) is a language model notable for its ability to achieve general-purpose language generation and other natural language processing tasks such as classification. LLMs can be used for text generation, a form of generative AI (e.g., GenAl, Gen AI, or GAl), by taking an input text and repeatedly predicting the next token or word. LLMs acquire these abilities by learning statistical relationships from text documents during a computationally intensive self-supervised and semi-supervised training process. Generative AI models, such as LLMs, are increasing in use and applicability over time.

Retrieval-augmented generation (RAG) is a technique that enables generative AI models to retrieve and incorporate new information. RAG modifies interactions with a generative AI model so that the model responds to user queries with reference to a specified set of documents, using this information to supplement information from its preexisting training data. This enables the generative AI model to use domain-specific and/or updated information. Use cases include providing chatbot access to internal company data or generating responses based on authoritative sources. Unlike traditional LLMs that rely on static training data, RAG pulls relevant text from databases, uploaded documents, or web sources. By dynamically retrieving information, RAG enables AI to provide more accurate responses without frequent retraining. However, responses generated by conventional RAG systems often struggle with capturing the query's intent. Additionally, conventional RAG systems capture new relevant information that becomes available by repeatedly transmitting the same query.

It is in this context that embodiments of the disclosure arise.

### SUMMARY

Embodiments of the present disclosure relate to systems and methods for generating artificial intelligence (AI) model responses using bidirectional embedding searches. The systems are used to represent searches as embedding vectors defining synthesized intent behind the query, and store the embedded representation of the search in a vector database. When new artifact is received, the systems are enabled to search the vector database using new data identified from the new artifact to determine which searches would have been mapped to the new data. Based on the mapping, the systems can automatically generate and/or execute a set of actions, such as generating an alert or notification, transmitting the new data to a model, etc.

In one embodiment, a method for generating responses using embedding searches, is disclosed. The method includes receiving, from a user interface of a computing device, an output generation request comprising a query for generation of an output. The method further includes determining a label for the query that indicates an expected output of the output generation request. A training dataset is constructed using a set of large language models (LLMs). The training dataset includes a first series of synthetic artifacts with labels satisfying the label of the query and a second series of synthetic artifacts with labels failing to satisfy the label of the query. A linear model is trained using the constructed training dataset to determine a set of model weights of the linear model, wherein the set of model weights comprises a vector representation of the expected output of the output generation request. The linear model is configured to map a particular non-synthetic artifact to the first series of synthetic artifacts or the second series of synthetic artifacts. A set of selected artifacts are identified from an artifact vector database comprising a plurality of vector representations of non-synthetic artifacts based on a degree of similarity between a vector representation of the set of model weights and a corresponding vector representation of each non-synthetic artifact in the artifact vector database. The set of selected artifacts are used to generate a response responsive to the query of the output generation request. The response represents a result of intent-synthesized bi-directional embedding search and is configured to be displayed on the user interface of the computing device.

In another embodiment, a system for generating responses using embedding searches, is disclosed. The system includes at least a query processing engine, a large language model (LLM ) intent analysis module, a training module and a database engine. The query processing engine is configured to receive, from a user interface of a computing device, an output generation request comprising a query for generation of an output and to determine a label for the query that indicates an expected output of the output generation request. The LLM intent analysis module is configured to engage a set of LLMs to construct a training dataset that includes a first series of synthetic artifacts with labels satisfying the label of the query and a second series of synthetic artifacts with labels failing to satisfy the label of the query. The training module is configured to use the constructed training dataset for training a linear model to determine a set of model weights of the linear model. The set of model weights is used to create a vector representation of the expected output of the output generation request. The linear model is trained by mapping a particular non-synthetic artifact to the first series of synthetic artifacts or the second series of synthetic artifacts. The database engine is configured to select a set of non-synthetic artifacts from an artifact vector database based on a degree of similarity between the vector representation of the expected output and a corresponding vector representation of each non-synthetic artifact in the artifact vector database.

In yet another embodiment, a non-transitory computer-readable medium including program instructions for performing a method used to generate responses using embedding searches. The program instructions include program instructions for receiving, from a user interface of a computing device, an output generation request comprising a query for generation of an output; program instructions for determining a label for the query that indicates an expected output of the output generation request; program instructions for constructing a training dataset using a set of large language models (LLMs), wherein the training dataset includes a first series of synthetic artifacts with labels satisfying the label of the query and a second series of synthetic artifacts with labels failing to satisfy the label of the query; program instructions for training a linear model using the constructed training dataset to determine a set of model weights of the linear model, wherein the set of model weights comprises a vector representation of the expected output of the output generation request. The linear model is configured to map a particular non-synthetic artifact to the first series of synthetic artifacts or the second series of synthetic artifacts. The non-transitory computer-readable medium further includes program instructions for identifying a set of selected artifacts from an artifact vector database comprising a plurality of vector representations of non-synthetic artifacts based on a degree of similarity between a vector representation of the set of model weights and a corresponding vector representation of each non-synthetic artifact in the artifact vector database; and program instructions for using the set of selected artifacts to generate a response responsive to the query of the output generation request. The response represents a result of intent-synthesized bi-directional embedding search and is configured to be displayed on the user interface of the computing device.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates an example environment of a synthesized search platform for generating artificial intelligence (AI) model responses using intent-synthesized bidirectional embedding searches, in accordance with some implementations of the technology.

FIG. 2 illustrates an example environment of a notification transmitted to a user interface of a computing device by a synthesized search platform in real-time (or near real-time) when new artifacts responsive to a query are detected, in accordance with some implementations of the technology.

FIG. 3 illustrates an example environment of conversation feedback in real-time (or near-real-time) that is generated and displayed by a synthesized search platform on a user interface of a computing device, in accordance with some implementations of the technology.

FIG. 4 illustrates an example environment of a synthesized search platform using intent-synthesized bidirectional embedding searches to return existing artifacts matching an intent of the query and notifications indicating new artifacts matching the intent of the query, in accordance with some implementations of the technology.

FIG. 5 is a flow diagram illustrating a process of generating AI model responses using intent-synthesized bidirectional embedding searches using a synthesized search platform, in accordance with some implementations of the technology.

FIG. 6 illustrates a layered architecture of an AI system that can implement the machine learning (ML) models of a synthesized search platform, in accordance with some implementations of the present technology.

FIG. 7 is a block diagram showing some of the components typically incorporated in at least some of the computer systems and other devices on which a synthesized search platform operates in accordance with some implementations of the present technology.

FIG. 8 is a system diagram illustrating an example of a computing environment in which a synthesized search platform operates in some implementations of the present technology.

The drawings have not necessarily been drawn to scale. For example, some components and/or operations are separated into different blocks or combined into a single block for the purposes of discussion of some of the implementations of the disclosed system. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Conventional retrieval systems, including traditional Retrieval Augmented Generation (RAG) approaches, typically operate by embedding user queries into high dimensional vector spaces. Conventional retrieval systems rely on pre-trained embedding models to transform textual input into dense vector representations that capture semantic meaning. Embedding models in conventional retrieval systems include Sentence-BERT variants such as the all-MiniLM-L6-v2, Nomic's nomic-embed-text-v1.5, AWS's Titan Embedding model, and OPENAI's text-embedding-ada-002. Once queries are embedded, conventional retrieval systems perform similarity searches within vector databases that include pre-embedded documents and/or information chunks. The similarity searches typically use indexing methods to increase efficiency over large datasets. Hierarchical Navigable Small World (HNSW) graphs are commonly used in conventional retrieval systems, using a logarithmic search complexity by constructing multi-layer graph structures for nearest neighbor identification. Another frequently used indexing method in conventional systems is Inverted File (IVF) Flat, which partitions the vector space into clusters.

Similarity metrics can be used in conventional retrieval systems to quantify a degree of similarity between vectors during the similarity search. Cosine similarity, for example, measures the cosine of the angle between two vectors. Cosine similarity ranges from -1 to 1, with 1 indicating identical orientation, 0 indicating orthogonality, and -1 indicating opposite orientation. L2 distance (Euclidean distance) measures the straight line distance between two points in Euclidean space. L2 distance is non-negative and equals zero only when the vectors are identical. Inner product is the sum of the products of corresponding entries of two vectors. Inner product can be positive, negative, or zero. In some implementations, the inner product is equivalent to the dot product when the inner product satisfies the axioms required for an inner product in standard Euclidean space, and thus the dot product can be used to measure a degree of similarity or alignment between vectors.

However, one of the primary challenges experienced by conventional retrieval systems is the occurrence of inaccurate or irrelevant retrieval results due to semantic gaps. Conventional retrieval systems typically rely on fixed embedding models that may not fully capture the nuanced intent behind user queries. The semantic representations generated by these models can sometimes fail to bridge the gap between the user's conceptual understanding and the conventional retrieval system's interpretation of the query. This mismatch can lead to the retrieval of irrelevant or only tangentially related information, particularly for complex or ambiguous queries. To mitigate these semantic limitations, some conventional systems resort to hybrid approaches that combine vector search with traditional information retrieval techniques such as Best Matching 25 (BM25). While this approach can improve recall by using both semantic and lexical matching, BM25 introduces additional complexity and potential inconsistencies. The need to balance and tune multiple retrieval mechanisms can lead to increased system complexity and maintenance overhead. Moreover, these hybrid systems may struggle to determine when to prioritize semantic similarity over lexical matching, potentially resulting in inconsistent or unpredictable search results across different types of queries.

Simplified keyword matching, which typically relies on exact or partial matches of query terms within documents, frequently misses semantically relevant content that does not contain the exact keywords used in the query, resulting in low recall. Conversely, they may retrieve irrelevant artifacts that happen to contain the query terms but in different contexts. Keyword matching systems further struggle to differentiate between synonyms, polysemy, and context-dependent meanings of words. On the other hand, rule-based filtering systems typically rely on manually generated rules to determine the relevance of documents to queries or to classify information. However, as the volume and complexity of information grow, maintaining an effective rule set becomes increasingly difficult and time-consuming. Rules often need frequent updates to account for new content types, evolving language usage, and changing user needs. The interdependencies between rules can further make modifications risky, as changes to one rule may have unintended consequences on others. Moreover, rule-based systems struggle to handle edge cases and nuanced queries that fall outside the scope of existing rules.

Another limitation of some conventional retrieval systems is the reliance on domain-specific embedding model training and retraining. As the scope of information or the domain of application changes, these conventional retrieval systems often require retraining of their embedding models to maintain accuracy. Not only is retraining time consuming and computationally expensive, but retraining can further lead to catastrophic forgetting. When models are retrained on new domain-specific data, the models may lose their ability to accurately represent information from previously learned domains, thus reducing accuracy for non-domain-specific semantic understanding. This trade-off between specialization and generalization poses a significant challenge, especially for systems that operate across diverse or evolving knowledge domains.

Some conventional systems use hierarchical summarization techniques by generating embeddings for individual chunks of documents and summaries of document sections. The embeddings and summaries are typically then indexed to enable search operations. For example, some conventional systems typically combine RAG with term based search methods such as BM25 (e.g., to improve search accuracy). However, this approach often leads to increased storage requirements and computational overhead due to the need to maintain and search multiple levels of embeddings and summaries. Additionally, the effectiveness of these conventional systems is limited by the quality of the generated summaries and the potential loss of context when searching at different hierarchical levels.

The computational expense of continuous re-querying for notification systems further creates another limitation of conventional retrieval approaches. In scenarios where users desire to be notified of new relevant information in real-time, conventional retrieval systems often periodically re-execute all active queries against new or updated content. This approach scales poorly as the number of queries and the frequency of content updates increase. The computational resources required for this continuous re-querying can become prohibitively expensive, leading to increased latency, reduced system responsiveness, and higher operational costs. Furthermore, this approach may not be able to deliver real-time notifications, as there is typically a delay between content updates and the next scheduled query execution.

As such, the inventors have developed systems and methods for generating artificial intelligence (AI) model responses using intent-synthesized bidirectional embedding searches (hereinafter the "synthesized search platform"). The synthesized search platform can (1) represent searches (e.g., inputs, queries, prompts, commands) as an embedding of a synthesized intent behind the query, rather than the query itself, and (2) store the embedded representation of the search in a vector database. The synthesized search platform is enabled to search the vector database using new data to determine which searches would have been mapped (e.g., associated, linked, matched) to the new data. Thus, the synthesized search platform can automatically generate and/or execute a set of actions such as generating an alert/notification, transmitting the new data to a model, and so forth.

In some implementations, the synthesized search platform can synthesize training data using LLMs to capture query intent, trains linear models to represent this intent, and employ bidirectional querying to enable information retrieval and real-time notifications. The synthesized search platform can use a set of LLMs to generate a spectrum of representative and non-representative results (e.g., synthetic dataset) that capture a label (e.g., an intent, which can be categorical or continuous) for obtained user queries. In some implementations, a user/human is enabled to manually generate/modify/input the training data. The synthetic dataset can be used to train a linear model (or other model) specific to each query, resulting in a set of model weights that represent the query's intent in vector space (e.g., the semantic space defined by the embedding model used such as AWS Titan V2, OPENAI text-embedding-ada-002, and so forth). Thus, when a new artifact is added, matching queries can be identified based on a similarity between the vector representations of the new artifact and the queries.

Instead of relying on fixed embeddings of queries and documents like conventional retrieval systems, the synthesized search platform creates an intent-based representation for each query that can be retrained and/or updated. The linear model's weights, which is a vector representation of the query intent, enable the retrieval of artifact (e.g., document) vectors that match the intent of the query. When searching for artifacts, the synthesized search platform does not simply identify a degree of similarity between the fixed query and artifact embeddings. Instead, the synthesized search platform uses the intent model weights to evaluate a degree of similarity between the query's intent and artifact embeddings.

Further, by embedding the linear model weights into a vector database, the synthesized search platform can efficiently search all queries simultaneously when new content is added. Instead of repeatedly executing individual queries against new content, the synthesized search platform treats new artifacts as queries against the database of stored intent representations. When a new artifact is added to the system, its vector representation is compared against the stored intent model weights of all existing queries. Thus, the synthesized search platform can identify which queries the new content is relevant to (e.g., matching intent), without re-executing each query individually. The efficiency gain is particularly significant as the number of active queries and the frequency of content updates increase.

In large-scale systems with millions of queries and frequent content updates, the synthesized search platform can reduce the computational requirements by orders of magnitude compared to conventional re-querying methods. For example, by indexing vectors using methods such as HNSW, IVF-Flat, and so forth, the synthesized search platform is enabled to rapidly approximate a nearest neighbor search in high-dimensional spaces and thus the synthesized search platform can quickly identify relevant (e.g., high degree of similarity/alignment between vectors) query intents when new data is added. In some implementations, the synthesized search platform scales logarithmically with the number of queries, rather than linearly as in conventional systems, and enables the synthesized search platform to process large query volumes and high-frequency content updates with reduced and/or minimal computational overhead.

Moreover, the synthesized search platform enables near-real-time or real-time actions. As soon as new content is added and embedded, the synthesized search platform can automatically determine all relevant queries and trigger actions accordingly. When the synthesized search platform identifies a match between new data and an existing search query, the synthesized search platform can initiate one or more actions, such as programmatic responses. For example, the actions can include making API calls to external systems, triggering the next step in an automated agent's decision-making process, triggering an alert/notification, and so forth. For example, in a research context, a match triggers particular updates to related datasets. The synthesized search platform reduces/eliminates the latency associated with periodic batch processing in traditional systems and ensures that users receive updates about new relevant information as soon as it becomes available. The reduced computational overhead further enables the synthesized search platform to retrieve a larger number of concurrent queries.

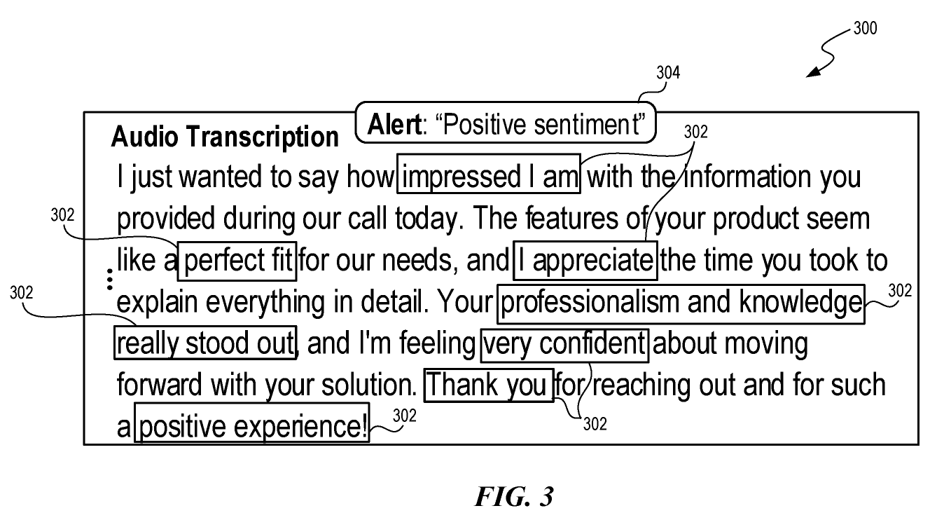

The synthesized search platform can support a variety of applications across multiple domains. For example, in enterprise settings, the synthesized search platform can identify a query intent (or multiple) to retrieve relevant documents from large corporate repositories. For customer support, the synthesized search platform can map user-reported issues to technical documentation and index new solutions in near real-time or real-time. In academic research, the synthesized search platform can use research questions to identify relevant literature (i.e., matching the intent of the research question) across disciplines and notify users of new publications matching their interests. For legal applications, the synthesized search platform can identify the intent of particular legal language to determine relevant clauses (i.e., matching the intent of the legal language) in document sets and monitor regulatory updates. In e-commerce, the synthesized search platform can match product attributes to user intents and transmit availability notifications. For content recommendation, the synthesized search platform can compare user interest models against new content vectors. During live discussions, the synthesized search platform can generate conversation vectors for near-real-time or real-time analysis, outline creation, and expert routing (further detail discussed with reference to FIG. 3).

While the current description provides examples of the models related to generative AI models and linear models, one of skill in the art would understand that the disclosed techniques can apply to other forms of machine learning (ML) or algorithms, including unsupervised, semi-supervised, supervised, and reinforcement learning techniques. For example, the disclosed synthesized search platform can use model outputs from knowledge graphs, support vector machine (SVM), k-nearest neighbor (KNN), decision-making, linear regression, random forest, na"ive Bayes, or logistic regression algorithms and/or other suitable computational models. In some implementations, the synthesized search platform adapts its operations based on the chosen model type. For instance, when using models that do not produce vector representations compatible with the embedding space, the synthesized search platform can use alternative similarity calculation methods or scoring techniques.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases "in some implementations," "in several implementations," "according to some implementations," "in the implementations shown," "in other implementations," and the like generally mean the specific feature, structure, or characteristic following the phrase is included in at least one implementation of the present technology and can be included in more than one implementation. In addition, such phrases do not necessarily refer to the same implementations or different implementations.

### Example Implementations of the Synthesized Search Platform

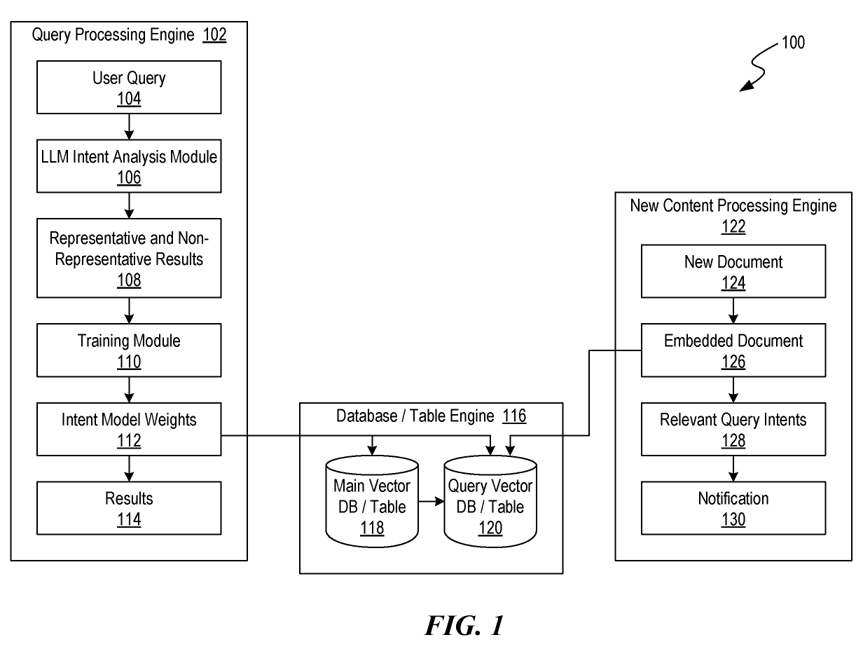

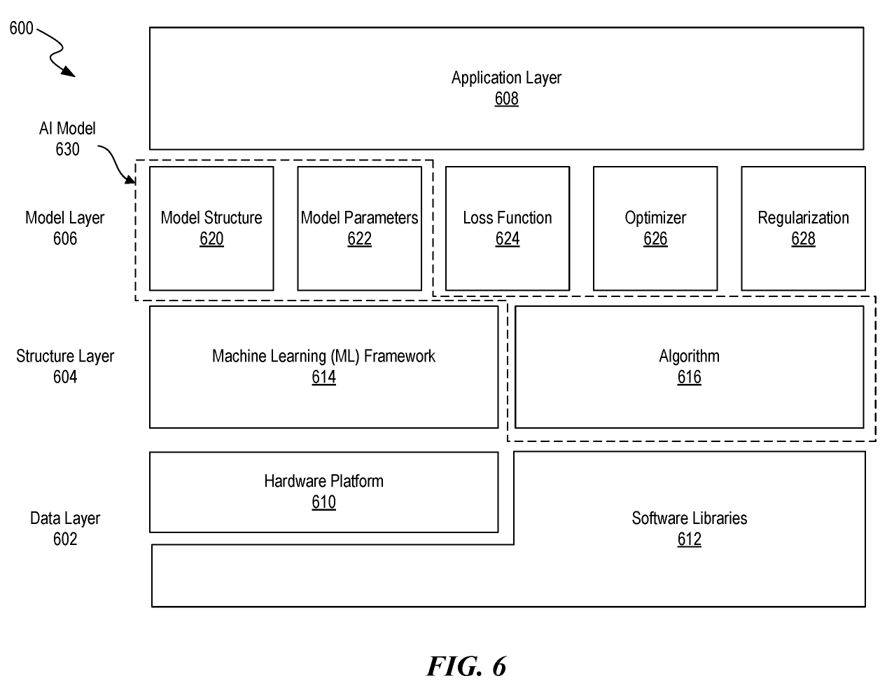

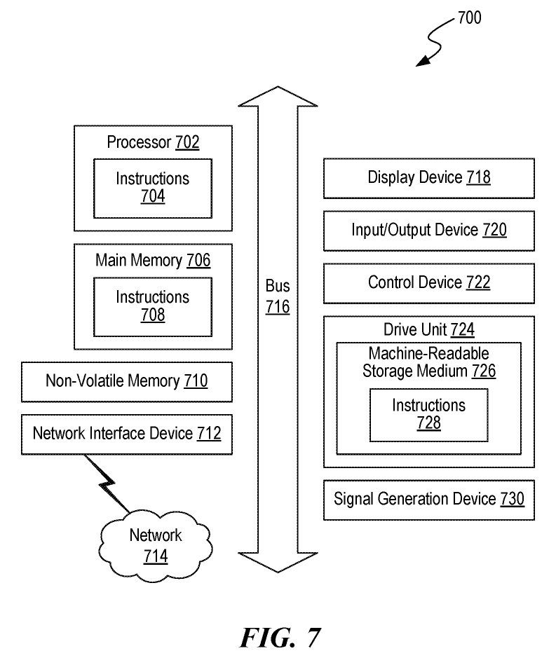

FIG. 1 illustrates an example environment 100 of a synthesized search platform for generating artificial intelligence (AI) model responses using intent-synthesized bidirectional embedding searches, in accordance with some implementations of the technology. The example environment 100 includes a query processing engine 102 that further includes a user query 104, an LLM intent analysis module 106, representative and non-representative results 108, a training module 110, intent model weights 112, and results 114. The synthesized search platform further includes a database engine 116 that includes a main vector database 118 and a query vector database 120. In some implementations, the synthesized search platform includes a new content processing engine 122 that includes a new document, a new embedded document 126, relevant query intents 128, and a notification 130. The example environment 100 can include one or more models that are the same as or similar to AI system 600, illustrated and described in more detail with reference to FIG. 6. The example environment 100 can be implemented using components of example computer system 700 illustrated and described in more detail with reference to FIG. 7. Implementations of the example environment 100 can include different and/or additional components or can be connected in different ways.

The user query 104, which can be a natural language input or structured search terms, is input into the LLM intent analysis module 106. The LLM intent analysis module 106 can include one or more models (e.g., LLMs, embedding models, and so forth) that tokenize the query, apply contextual embeddings, and use attention mechanisms to capture semantic relationships and query intent of the user query 104. For example, the LLM intent analysis module 106 partitions down the input query into individual tokens, which can include words, subwords, or characters (e.g., using WordPiece, Byte-Pair Encoding, SentencePiece, and so forth). Using an embedding model, the tokens can be mapped to corresponding embedding vectors, which are high-dimensional numerical representations that capture the semantic meaning of the tokens. The contextual embeddings can be generated based on the surrounding context of each token to produce dynamic, context-aware representations. The attention mechanisms can be implemented through multi-head self-attention layers and enable the model to assign weights to different parts of the user query 104 to capture long-range dependencies and/or relationships between the tokens within the user query 104.

Using the contextual embeddings of the user query 104, the LLM intent analysis module 106 can generate representative and non-representative results 108, which refer to a synthetically generated spectrum of desirable (i.e. representative) and undesirable (i.e. non-representative) results specific to the intent behind the user query 104 (as interpreted by the LLM intent analysis module 106). Each result generated by the LLM intent analysis module 106 can be assigned a similarity score using, for example, the embedding model used to generate the contextual embeddings for the user query 104. The embedding model can generate contextual embeddings for each result using the same or similar methods as those used to generate the user query 104 and determine a degree of similarity (e.g., cosine similarity, Euclidean distance) between the query embedding and each result embedding. In some implementations, representative results have higher similarity scores (e.g., >0.7), while non-representative results score lower (e.g., <0.3). In some implementations, each generated result is tagged with metadata such as its classification (e.g., representative, non-representative), similarity score, generation method, and so forth.

To generate non-representative results, the synthesized search platform can generate examples that are syntactically similar but semantically different from the query intent. The synthesized search platform, in some implementations, replaces key terms with semantically distant but contextually plausible alternatives. For instance, given a query about "renewable energy," the synthesized search platform substitutes "renewable" with "traditional" or "fossil," thus altering the semantic meaning. In some implementations, the synthesized search platform identifies words that are distant in the semantic space (i.e., distant within the latent space of the contextual embedding of the user query 104). The synthesized search platform can set an upper and/or lower threshold, such as selecting words with a cosine similarity below 0.3, to ensure a semantic distance over a particular value. Additionally, the synthesized search platform can group words in the semantic space and select words from clusters far from the original term's cluster.

The training module 110 uses the generated synthetic dataset of representative and non-representative results 108 to train one or more models (e.g., a linear model) specific to the query intent. Each synthetic result can be transformed into a high dimensional feature vector (e.g., using Term Frequency-Inverse Document Frequency (TF-IDF), BERT, and so forth). The training module 110 can train one or more models, such as logistic regression, support vector machines (SVM) with linear or non-linear kernels, random forests, gradient boosting machines (e.g., XGBoost, LightGBM), neural networks, and so forth, to identify the decision boundary between representative and nonrepresentative results. In some implementations, the training module 110 combines multiple models (e.g., multiple linear models) trained on different subsets of the data or with different initializations by, for example, averaging the weights of each model. The resulting trained model can be represented by the resulting intent model weights 112, which can be a weight vector and bias term that captures the learned notion of relevance specific to the original query intent. The intent model weights 112 can be stored in the query vector database 120. The query vector database 120 stores vector representations of processed queries and their associated intent model weights 112.

The resulting intent model weights 112 are used by the query processing engine 102 to score and/or rank results 114 from the main vector database 118 of the database/table engine 116. For example, the results 114 can be scored/ranked by determining the dot product between the intent model weights 112 vector and the vector representations of results 114 stored in the main vector database 118. The main vector database 118 refers to one or more databases storing the information/content used by the query processing engine 102 to generate the results 114. For example, the main vector database 118 includes data used by an LLM within the query processing engine 102 to generate a response to the user query 104. In some implementations, the query processing engine 102 stops scoring/ranking results 114 once a particular number of high-scoring results 114 are identified.

When a new document 124 is obtained by the synthesized search platform, the new content processing engine 122 transforms the new document 124 into the embedded document 126 by tokenizing the new document 124 and passing the tokens through a pre-trained embedding model (e.g., the same or similar embedding model used by the query processing engine 102) to create a high-dimensional vector representation of the content of the new document 124. The new content processing engine 122 performs a similarity search between the embedding of the new document 124 and the stored query intent representations in the query vector database 120.

When matches are identified, such as when the degree of similarity between the embedding of the new document 124 and one or more stored query intent representations in the query vector database 120 satisfy a particular threshold, the new content processing engine 122 can trigger the notification 130 to be transmitted to a computing device. The notification 130 can be transmitted via one or more communication protocols (e.g., webhooks, push notifications, or email) to alert users or automatically update one or more system components. The specific notification method can be determined based on input user preferences or system-defined rules (e.g., a decision tree or rule-based system that identifies a particular notification channel given the user query 104).

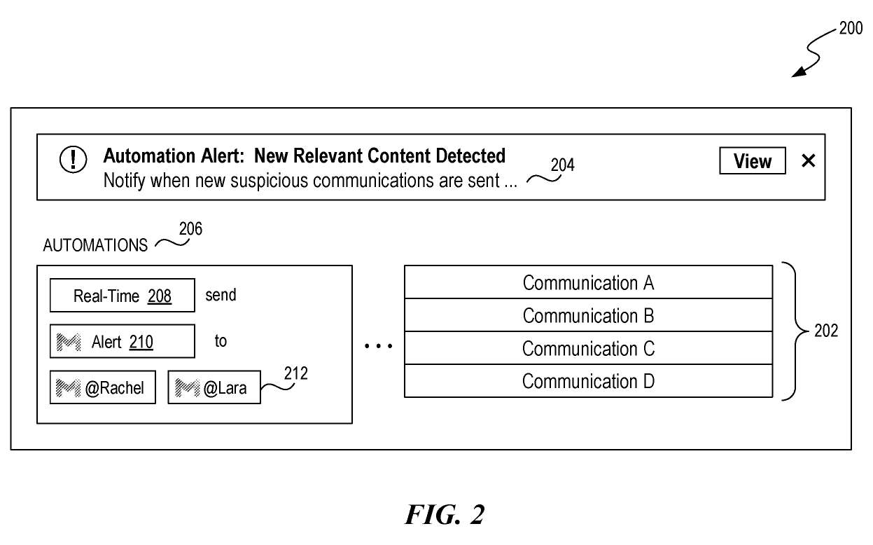

FIG. 2 illustrates an example environment 200 of a notification transmitted to a user interface of a computing device by a synthesized search platform in real-time (or near-real-time) when new artifacts responsive to a query are detected, in accordance with some implementations of the technology. The example environment 200 includes matching artifacts 202, notification 204, notification automation settings 206, notification frequency 208, notification type 210, and notification recipients 212. The example environment 200 can include one or more models that are the same as or similar to AI system 600, illustrated and described in more detail with reference to FIG. 6. The example environment 200 can be implemented using components of example computer system 700 illustrated and described in more detail with reference to FIG. 7. Implementations of the example environment 200 can include different and/or additional components or can be connected in different ways.

The matching artifacts 202 represent the content or data items that have been identified as relevant to a user's query (e.g., the user query 104) by the synthesized search platform via the intent-synthesized bidirectional embedding search. The matching artifacts 202 can include documents, database records, or other structured or unstructured data that semantically align with the query intent. The notification 204 is a user interface element that can alert the user of newly detected relevant content. This notification can be generated in real-time or near-real-time, and can include metadata associated with the matching artifacts 202, such as titles, timestamps, relevance scores, and so forth.

The notification automation settings 206 enable users to configure the behavior of the notification system. The notification automation settings 206 can include one or more rule-based engines that define conditions for notification triggering, where users can set thresholds for relevance scores, specify time windows for notification delivery, define Boolean combinations of content attributes to be met for a notification to be generated, and so forth. For example, a notification automation setting can include the notification frequency 208, which determines how often notifications are sent to the user. Frequency options can range from real-time updates to daily or weekly digests. The notification type 210 specifies the format and delivery method of the notification. For example, notification types 210 include email alerts, push notifications to mobile devices, in-app messages, integration with third-party messaging platforms, and so forth. The notification recipients 212 define the target audience for each notification. The notification recipients 212 can use role-based access control (RBAC) or attribute-based access control (ABAC) models to determine notification eligibility. In some implementations, the synthesized search platform can assign roles to users (e.g., "analyst", "manager", "executive") and associate specific notification types or content categories with each role. The synthesized search platform can consider multiple attributes of the user when transmitting the notification. For example, the synthesized search platform can use a user's department, security clearance level, project assignments, and/or current location to determine if they should receive a particular notification.

FIG. 3 illustrates an example environment 300 of conversation feedback in realtime (or near-real-time) that is generated and displayed by a synthesized search platform on a user interface of a computing device, in accordance with some implementations of the technology. The example environment 300 includes matching artifacts 202 and conversation feedback 304. The example environment 300 can include one or more models that are the same as or similar to AI system 600, illustrated and described in more detail with reference to FIG. 6. The example environment 300 can be implemented using components of example computer system 700 illustrated and described in more detail with reference to FIG. 7. Implementations of the example environment 300 can include different and/or additional components or can be connected in different ways.

The matching artifacts 302 are the same as or similar to the matching artifacts 202 with reference to FIG. 2, and can correspond to an ongoing conversation. In FIG. 3, the matching artifacts 302 are identified as highlighted phrases within the audio transcription, such as "impressed I am", "perfect fit", "appreciate", "professionalism and knowledge", "really stood out", "very confident", "Thank you", and "positive experience". The synthesized search platform can use overlapping sliding windows to ensure continuity in an ongoing conversation and enable the synthesized search platform to identify and highlight the matching artifacts 302 in real-time or near-real-time as the conversation progresses.

The conversation feedback 304 can be the same as or similar to the notification 204 in FIG. 2. In FIG. 3, the conversation feedback 304 is identified by the "Alert: 'Positive sentiment'" notification at the top of the transcription box. The conversation feedback 304 can indicate, for example, an overall sentiment in addition to the specific sentiment-laden phrases (e.g., the matching artifacts 302). In FIG. 3, the abundance of positive phrases such as "impressed", "perfect fit", and "very confident" has triggered a positive sentiment alert.

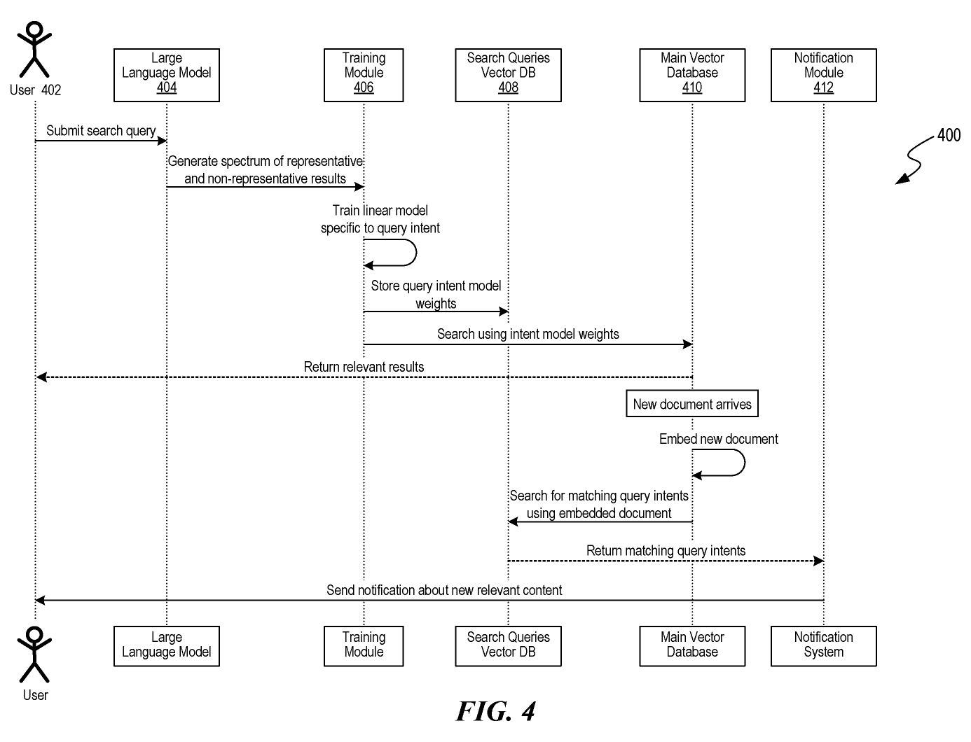

FIG. 4 illustrates an example environment 400 of a synthesized search platform using intent-synthesized bidirectional embedding searches to return existing artifacts matching an intent of the query and notifications indicating new artifacts matching the intent of the query, in accordance with some implementations of the technology. The example environment 400 includes a user 402, an LLM 404, a training module 406, a search query vector database 408, a main vector database 410, and a notification module 412. The example environment 400 can include one or more models that are the same as or similar to AI system 600, illustrated and described in more detail with reference to FIG. 6. The example environment 400 can be implemented using components of example computer system 700 illustrated and described in more detail with reference to FIG. 7. Implementations of the example environment 400 can include different and/or additional components or can be connected in different ways.

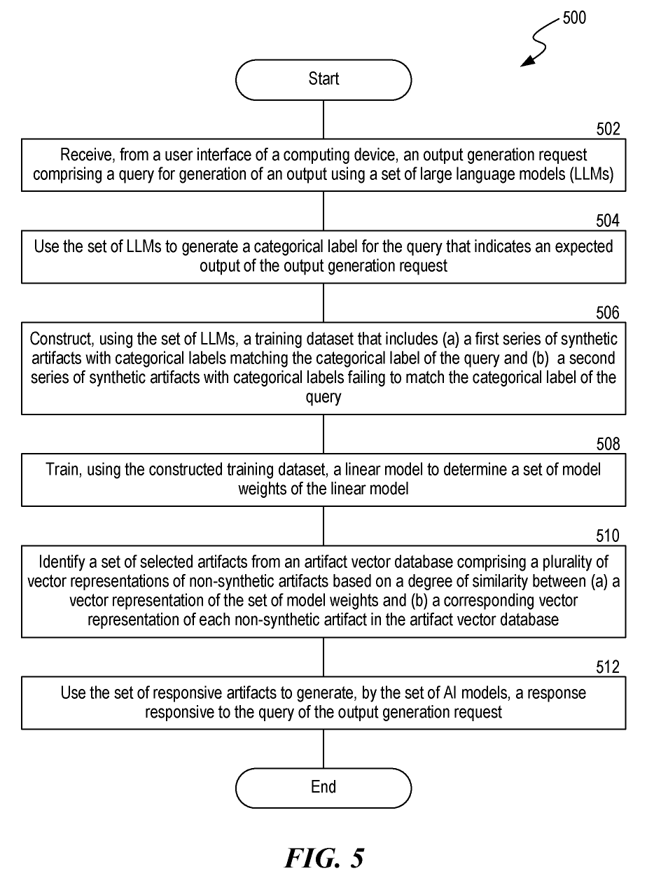

The user 402 is enabled to submit a search query to the LLM 404 (e.g., the LLM intent analysis module 106 in FIG. 1). The LLM 404, which could be based on transformer architectures like GPT or BERT, processes the query to identify its semantic intent using methods discussed with reference to FIG. 1 and 5. As shown in FIG. 4, the LLM 404 generates a spectrum of representative and non-representative results based on the query. The training module 406 receives the output (e.g., the spectrum of representative and non-representative results) from the LLM 404 and uses the output to train a linear model specific to the query intent. The model is enabled to, for example, distinguish between relevant and irrelevant content based on the generated spectrum of representative and non-representative results. The training module 406 extracts the query intent model weights from the model, which refer to vector representations of the learned relevance criteria.

The intent model weights can be stored in the search query vector database 408, which refers to a repository for the processed query intents. The main vector database 410 includes the vector representations of content requested by the user 402. The synthesized search platform uses the intent model weights to search the main vector database 410 using methods discussed with reference to FIG. 1 and 5. The search queries vector database 408 and the main vector database 410 are the same as or similar to the query vector database 120 and the main vector database 118 with reference to FIG. 1, respectively. In some implementations, the content in the main vector database 410 is directly transmitted to the computing device of the user 402. In other implementations, the LLM 404 uses the content in the main vector database 410 to generate a response that is responsive to the search query of the user 402.

The bidirectional nature of the synthesized search platform is demonstrated in the lower portion of the figure. When a new document (or other artifacVcontent) is obtained (e.g., added to the main vector database 410), it is embedded into a vector representation (e.g., using the same embedding model as used for the existing content). The synthesized search platform searches for matching query intents by using this embedded document against the search query vector database 408. The reverse search enables the synthesized search platform to identify which existing queries the new document is relevant to, without re-running every query. The notification module 412 uses the matching queries to send notifications about new relevant content within the new document to the corresponding users (e.g., the user 402).

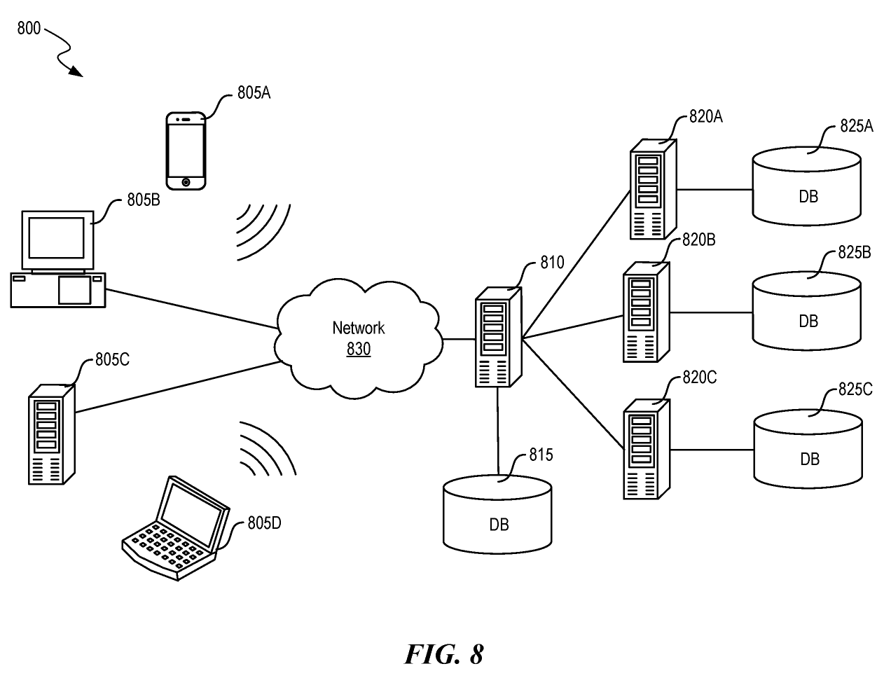

FIG. 5 is a flow diagram 500 illustrating a process of generating AI model responses using intent-synthesized bidirectional embedding searches using a synthesized search platform, in accordance with some implementations of the technology. In some implementations, the example process 500 is performed by a system (e.g., the synthesized search platform) including components of the example computing environment 800 illustrated and described in more detail with reference to FIG. 8. The system can be implemented on a terminal device, on a server, or on a telecommunications network core. Likewise, implementations can include different and/or additional operations or can perform the operations in different orders.

In operation 502, the synthesized search platform receives, from a user interface of a computing device, an output generation request that includes a query for generation of an output (e.g., using a set of LLMs or other AI model). The query input (e.g., the user query 104) can be in natural language form, structured as specific search terms, and/or in the form of some other mode (e.g., image, video, audio). The user interface can be a web-based application, a mobile app, a desktop software client, and so forth.

In operation 504, using the set of LLMs (or received user input), the synthesized search platform generates/determines/obtains a label (e.g., a query intent) for the query that indicates an expected output of the output generation request. The LLMs, which can include transformer-based models, can encode the input query into a contextualized vector representation. In some implementations, to generate a label for the query, the synthesized search platform can generate a probability distribution across a set of predefined intents and select the intent with the highest probability. For example, the synthesized search platform can identify vector representations of intents with a greater degree of similarity (e.g., cosine similarity, Euclidean distance) to the contextualized vector representation of the input query. In some implementations, the synthesized search platform assigns multiple intents to the query. Here, instead of assigning a single label, the LLM(s) predict probabilities for groups of multiple intents.

In some implementations, rather than being selected from a predefined set of labels, the label can be dynamically determined. For example, the synthesized search platform can use a feed-forward neural network trained on a corpus of labeled intents. To account for the dynamic nature of user queries (i.e., that they can be retrained and/or updated), the synthesized search platform can perform a coarse-grained classification first to identify broad intent categories, followed by fine-grained classification within the identified category. In some implementations, the set of LLMs includes models fine-tuned on different domains or datasets and/or models with varying architectures (e.g., LSTM based models alongside transformer-based ones). The intent prediction can be determined by aggregating the predicted intents of multiple LLMs using, for example, majority voting, weighted averaging based on model confidence scores, and so forth. In some implementations, the synthesized search platform uses contextual information beyond the query itself, such as user history, session data, and/or domain-specific knowledge bases. The additional context can be integrated using attention mechanisms or through separate encoders that are then combined with the query representation.

In operation 506, the synthesized search platform constructs, using the set of LLMs (or received user input), a training dataset that includes (a) a first series of synthetic artifacts with labels satisfying (e.g., matching) the label of the query (e.g., representative results) and (b) a second series of synthetic artifacts with labels failing to satisfy the label of the query (e.g., non-representative results). To generate representative artifacts, the LLMs can be prompted with the query's label and/or other obtained context as a conditioning input. The LLMs can generate examples that semantically align with the intended category. For example, if the query intent is "weather forecast," the prompt can be structured as "Generate a weather forecast for:". Then, the LLMs then use this context to produce representative artifacts. To increase diversity, the synthesized search platform can cause the set of LLMs to select from the top p% of the probability distribution when choosing the next token to maintain coherence while allowing for variability. Further, the synthesized search platform can adjust the temperature, or degree of "randomness" of the model's output, with higher temperatures producing more diverse results.

To generate non-representative results, the LLMs can be prompted with the query's label and/or other obtained context as a conditioning input and instructed to generate examples that fail to semantically align with the intended category. In some implementations, the synthesized search platform can use a discriminator model trained to identify artifacts matching the query intent, and then use gradient-based optimization to generate examples that maximize (or otherwise increase) the discriminator's misclassification rate. In some implementations, the synthesized search platform uses a knowledge graph to generate semantically distant but topically related artifacts. By traversing a domain-specific knowledge graph, the synthesized search platform can identify concepts that are related to the query topic but belong to different labels. The concepts can then be used as seeds for generating the non-matching artifacts.

In some implementations, the synthesized search platform generates a continuum of artifacts that range from highly similar to increasingly divergent from the query intent. The synthesized search platform can use one or more similarity scoring metrics, such as a cosine similarity or Euclidean distance between the intent's/label's embedding and each generated artifact's embedding. For example, representative artifacts score higher (e.g., >0.7), while non-representative ones score lower (e.g., <0.3). The synthesized search platform generates examples across a range, including those falling in the middle (e.g., 0.3-0.7). To achieve this distribution, the synthesized search platform can use controlled text generation, where the degree of semantic drift from the original intent is gradually increased. The synthesized search platform can further identify underrepresented regions in the spectrum. When gaps are detected, the synthesized search platform can adapt its prompts or generation parameters to produce more artifacts in those areas. In some implementations, the synthesized search platform divides the similarity score range into multiple strata (e.g., 0-0.2, 0.2-0.4, 0.4-0.6, 0.6-0.8, 0.8-1.0) and samples a predetermined number of examples from each stratum.

In operation 508, the synthesized search platform trains, using the constructed training dataset, a linear model (or other model) to determine a set of model weights for the linear model. The linear model can map a particular non-synthetic artifact to the first series of synthetic artifacts or the second series of synthetic artifacts. The linear model can be initialized with random model weights. For each training example, the model can generate a prediction (e.g., representative or not representative) based on its current weights. A mean squared error loss function can be used to measure the difference between the predicted values and the true labels (representative or not representative). The mean squared error can be calculated by taking the average of the squared differences between the predicted and actual values. In some implementations, a binary cross-entropy loss function can be used to measure the value of the error of the prediction from the true label (representative or not representative).

The synthesized search platform can calculate the gradient of this loss with respect to each of the model's weights. The gradient indicates how much each weight contributes to the error and in which direction the weight should be adjusted to reduce the error. Over multiple epochs, the model's weights can be gradually refined that results in an improved performance in distinguishing between matching and non-matching artifacts. After training the linear regression model using mean squared error, Platt scaling can be applied to calibrate the model's output into probabilities by fitting a logistic regression model to the outputs of the trained linear model to transform the raw scores produced by the linear regression into calibrated probability estimates, providing an interpretable measure of confidence in the model's predictions. The set of model weights includes a vector representation of the expected output of the output generation request.

In operation 510, the synthesized search platform identifies a set of selected artifacts from an artifact vector database (e.g., main vector database 118 in FIG. 1) comprising a plurality of vector representations of non-synthetic artifacts based on a degree of similarity (e.g., cosine similarity, Euclidean distance) between (a) a vector representation of the set of model weights and (b) a corresponding vector representation of each non-synthetic artifact in the artifact vector database. The artifact vector database stores a collection of vector representations corresponding to artifacts (non-synthetic or synthetic), each encoded as high-dimensional vectors. In some implementations, the synthesized search platform can identify k artifacts in the vector database whose representations have the highest degree of similarity to the query vector (derived from the model weights). The value of k can be dynamically adjusted based on factors such as query complexity and desired result set size. In some implementations, the synthesized search platform identifies artifacts in the vector database whose representations have a degree of similarity to the query vector that exceeds a specified threshold. For example, on a -1 to 1 scale, the synthesized search platform selects all artifacts with a similarity score above 0.2. The threshold can be dynamically adjusted based on factors such as query complexity, desired result set size, specific use case requirements, and so forth.

As the search progresses through the indexed vector space, the synthesized search platform maintains a priority queue of the top k matches found so far, continuously updating it as matches with a greater degree of similarity are identified.

In operation 512, the synthesized search platform uses the set of responsive artifacts to generate (e.g., using the set of AI models) a response responsive to the query of the output generation request. The response can be displayed on the user interface of the computing device. The synthesized search platform can aggregate the selected artifacts to use as context for the AI models when generating the response.

In some implementations, the synthesized search platform stores the set of model weights of the linear model in a query vector database that includes a plurality of vector representations of expected outputs of corresponding output generation requests. When the synthesized search platform receives an indication of a modification of the artifact vector database to add a vector representation of an additional artifact to the artifact vector database, the synthesized search platform can identify a set of matching queries of corresponding output generation requests from the query vector database based on a degree of similarity between (a) the vector representation of the additional artifact and (b) a corresponding vector representation of each expected output in the query database. The synthesized search platform can trigger one or more programmatic workflows on the computing device to cause display of, on the user interface, a representation of the additional artifact.

The output of the search (e.g., the set of matching queries of corresponding output generation requests, the set of selected artifacts from the artifact vector database), can be further processed using an AI model such as a Large Language Model (LLM) for additional verification, validation, summarization, and so forth. The AI model can verify the relevance of each matching query/artifact individually to the original intent and can provide additional context or explanations. For example, an LLM can be prompted with a task-specific instruction, such as "Determine if the following artifact is relevant to the given query." The LLM can output a binary decision, a confidence score, and/or an explanation of its reasoning to filter out false positives that may have been retrieved due to superficial similarity in the vector space. In some implementations, the AI model can generate an overall summary of the matching queries/artifacts. Thus, the synthesized search platform is enabled to replace traditional RAG methods.

### Example Implementation of the Models of the Synthesized Search Platform

FIG. 6 illustrates a layered architecture of an AI system 600 that can implement the ML models of the synthesized search platform of FIG. 1, in accordance with some implementations of the present technology. Example ML models can include the models executed by the synthesized search platform, such as the LLM 404 in FIG. 4. Accordingly, the models of the synthesized search platform can include one or more components of the AI system 600.

As shown, the AI system 600 can include a set of layers, which conceptually organize elements within an example network topology for the AI system's architecture to implement a particular AI model. Generally, an AI model is a computer-executable program implemented by the AI system 600 that analyzes data to make predictions. Information can pass through each layer of the AI system 600 to generate outputs for the AI model. The layers can include a data layer 602, a structure layer 604, a model layer 606, and an application layer 608. The algorithm 616 of the structure layer 604 and the model structure 620 and model parameters 622 of the model layer 606 together form an example AI model. The loss function engine 624, optimizer 626, and regularization engine 628 work to refine and optimize the AI model, and the data layer 602 provides resources and support for application of the AI model by the application layer 608.

The data layer 602 acts as the foundation of the AI system 600 by preparing data for the AI model. As shown, the data layer 602 can include two sub-layers: a hardware platform 610 and one or more software libraries 612. The hardware platform 610 can be designed to perform operations for the AI model and include computing resources for storage, memory, logic, and networking, such as the resources described in relation to FIGS. 7 and 8. The hardware platform 610 can process amounts of data using one or more servers. The servers can perform backend operations such as matrix calculations, parallel calculations, ML training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (1/0) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include computing resources, (e.g., servers, memory, etc.) offered by a cloud services provider. The hardware platform 610 can also include computer memory for storing data about the AI model, application of the AI model, and training data for the AI model. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, enabling them to run quickly with a small memory footprint. Examples of software libraries 612 that can be included in the AI system 600 include INTEL Math Kernel Library, NVIDIA cuDNN, EIGEN, and OpenBLAS.

The structure layer 604 can include an ML framework 614 and an algorithm 616. The ML framework 614 can be thought of as an interface, library, or tool that enables users to build and deploy the AI model. The ML framework 614 can include an opensource library, an API, a gradient-boosting library, an ensemble method, andlor a deep learning toolkit that work with the layers of the AI system to facilitate development of the AI model. For example, the ML framework 614 can distribute processes for application or training of the AI model across multiple resources in the hardware platform 610. The ML framework 614 can also include a set of pre-built components that have the functionality to implement and train the AI model and enable users to use pre-built functions and classes to construct and train the AI model. Thus, the ML framework 614 can be used to facilitate data engineering, development, hyperparameter tuning, testing, and training for the AI model. Examples of ML frameworks 614 that can be used in the AI system 600 include TENSORFLOW, PYTORCH, SCIKIT-LEARN, KERAS, Light GBM, RANDOM FOREST, and AMAZON WEB SERVICES.

The algorithm 616 can be an organized set of computer-executable operations used to generate output data from a set of input data and can be described using pseudocode. The algorithm 616 can include complex code that enables the computing resources to learn from new input data and create new/modified outputs based on what was learned. In some implementations, the algorithm 616 can build the AI model through being trained while running computing resources of the hardware platform 610. This training enables the algorithm 616 to make predictions or decisions without being explicitly programmed to do so. Once trained, the algorithm 616 can run at the computing resources as part of the AI model to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of image prompt 102 in FIG. 1) from various source computing systems described in relation to FIG. 1. Furthermore, training data can include pre-processed data generated by various engines of the synthesized search platform described in relation to FIGS. 1-5. The user may label the training data based on one or more classes and trains the AI model by inputting the training data to the algorithm 616. The algorithm 616 determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine whether the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can include classification and/or regression. Classification techniques include teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques include estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning-based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format. The synthesized search platform can use unsupervised learning to identify patterns in claim history (e.g., to identify particular event sequences) and so forth. In some implementations, performance of the models of the synthesized search platform that can use unsupervised learning is improved because the incoming user query 104 are preprocessed and reduced, based on the relevant triggers, as described herein.

A few techniques can be used in supervised learning: clustering, anomaly detection, and techniques for learning latent variable models. Clustering techniques include grouping data into different clusters that include similar data, such that other clusters contain dissimilar data. For example, during clustering, data with possible similarities remain in a group that has fewer or no similarities to another group. Examples of clustering techniques include density-based methods, hierarchical-based methods, partitioning methods, and grid-based methods. In one example, the algorithm 616 may be trained to be a k-means clustering algorithm, which partitions observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or k-nearest neighbor (k-NN) algorithm. Latent variable techniques include relating observable variables to a set of latent variables. These techniques assume that the observable variables are the result of an individual's position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI model using data from the data layer 602 and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model of the AI system 600. The model structure 620 defines the complexity of the pattern/relationship that the AI model expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 620 may include one or more hidden layers of nodes between the input and output layers. The model structure 620 can be an artificial neural network (or, simply, neural network) that connects the nodes in the structured layers such that the nodes are interconnected. Examples of neural networks include feedforward neural networks, CNNs, recurrent neural networks (RNNs), autoencoder, and generative adversarial networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's performance during training. For instance, the loss function engine 624 can measure the difference between a predicted output of the AI model and the actual output of the AI model and is used to guide optimization of the AI model during training to minimize the loss function. The loss function may be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model. Examples of optimizers include Gradient Descent (GO), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents over- and underfitting of the AI model. Overfitting occurs when the algorithm 616 is overly complex and too adapted to the training data, which can result in poor performance of the AI model. Underfitting occurs when the algorithm 616 is unable to recognize even basic patterns from the training data such that it cannot perform well on training data or on validation data. The optimizer 626 can apply one or more regularization techniques to fit the algorithm 616 to the training data properly, which helps constrain the resulting AI model and improves its ability for generalized application. Examples of regularization techniques include lasso (L1) regularization, ridge (L2) regularization, and elastic (L1 and L2) regularization.

The application layer 608 describes how the AI system 600 is used to solve problems or perform tasks. In an example implementation, the application layer 608 can include a front-end user interface of the synthesized search platform.

### Example Computing Environment of the Synthesized Search Platform

FIG. 7 is a block diagram showing some of the components typically incorporated in at least some of the computer systems 700 and other devices on which the disclosed system operates in accordance with some implementations of the present technology. As shown, an example computer system 700 can include: one or more processors 702, main memory 708, non-volatile memory 712, a network interface device 714, a video display device 720, an input/output device 722, a control device 724 (e.g., keyboard and pointing device), a drive unit 726 that includes a machine-readable medium 728, and a signal generation device 732 that are communicatively connected to a bus 718. The bus 718 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture to that of a server computer, personal computer (PC), tablet computer, mobile telephone, game console, music player, wearable electronic device, network-connected ("smart") device (e.g., a television or home assistant device), AR/VR systems (e.g., head-mounted display), or any electronic device capable of executing a set of instructions that specify action(s) to be taken by the computer system 700. In some implementations, the computer system 700 can be an embedded computer system, a system-on-chip (SOC), a single-board computer system (SSG) or a distributed system such as a mesh of computer systems or can include one or more cloud components in one or more networks. Where appropriate, one or more computer systems 700 can perform operations in real time, in near real time, or in batch mode.

The network interface device 714 enables the computer system 700 to exchange data in a network 716 with an entity that is external to the computer system 700 through any communication protocol supported by the computer system 700 and the external entity. Examples of the network interface device 714 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 708, non-volatile memory 712, machine-readable medium 728) can be local, remote, or distributed. Although shown as a single medium, the machine-readable medium 728 can include multiple media (e.g., a centralized/distributed database and/or associated caches and servers) that store one or more sets of instructions 730. The machine-readable (storage) medium 728 can include any medium that is capable of storing, encoding, or carrying a set of instructions for execution by the computer system 700. The machine-readable medium 728 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as "computer programs"). The computer programs typically comprise one or more instructions (e.g., instructions 710, 730) set at various times in various memory and storage devices in computing device(s). When read and executed by the processor 702, the instruction(s) cause the computer system 700 to perform operations to execute elements involving the various aspects of the disclosure.

FIG. 8 is a system diagram illustrating an example of a computing environment 800 in which the disclosed system operates in some implementations. In some implementations, the computing environment 800 includes one or more client computing devices 805A-D, examples of which can host the synthesized search platform. Client computing devices 805 operate in a networked environment using logical connections through network 830 to one or more remote computers, such as a server computing device.

In some implementations, server 810 (e.g., server computing device) is an edge server that receives client requests and coordinates fulfillment of those requests through other servers, such as servers 820A-C. In some implementations, server computing devices 810 and 820 comprise computing systems, such as the synthesized search platform. Though each server computing device 810 and 820 is displayed logically as a single server, each server computing device can be a distributed computing environment encompassing multiple computing devices located at the same or at geographically disparate physical locations. In some implementations, each server 820 corresponds to a group of servers.

Client computing devices 805 and server computing devices 81 0 and 820 can each act as a server or client to other server or client devices. In some implementations, servers (810, 820A-C) connect to a corresponding database (815, 825A-C). As discussed above, each server 820 can correspond to a group of servers, and each of these servers can share a database or can have its own database. Databases 815 and 825 warehouse (e.g., store) information such as claims data, email data, call transcripts, call logs, policy data, and so on. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. In some implementations, network 830 is the Internet or some other public or private network. Client computing devices 805 are connected to network 830 through a network interface, such as by wired or wireless communication. While the connections between server 810 and servers 820 are shown as separate connections, these connections can be any kind of local, wide area, wired, or wireless network, including network 830 or a separate public or private network.

### Conclusion

Unless the context clearly requires otherwise, throughout the description and the claims, the words "comprise," "comprising," and the like are to be construed in an inclusive sense, as opposed to an exclusive or exhaustive sense-that is to say, in the sense of "including, but not limited to." As used herein, the terms "connected," "coupled," and any variants thereof mean any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number can also include the plural or singular number, respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include additional elements to those implementations noted above or can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification unless the above Detailed Description section explicitly defines such terms. Accordingly, the actual scope of the technology encompasses not only the disclosed examples but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right after filing this application to pursue such additional claim forms, either in this application or in a continuing application.

From the foregoing, it will be appreciated that specific implementations of the invention have been described herein for purposes of illustration but that various modifications can be made without deviating from the scope of the invention. Accordingly, the invention is not limited except as by the appended claims.

1. A computer-implemented method for generating responses using embedding searches, the method comprising:
receiving, from a user interface of a computing device, an output generation
request comprising a query for generation of an output;
determining a label for the query that indicates an expected output of the output
generation request;
constructing, using a set of large language models (LLMs), a training dataset that
includes (a) a first series of synthetic artifacts with labels satisfying the
label of the query and (b) a second series of synthetic artifacts with labels
failing to satisfy the label of the query;
training, using the constructed training dataset, a linear model to determine a set
of model weights of the linear model,
wherein the linear model is configured to map a particular non-synthetic
artifact to the first series of synthetic artifacts or the second series of
synthetic artifacts, and
wherein the set of model weights comprises a vector representation of the
expected output of the output generation request;
identifying a set of selected artifacts from an artifact vector database comprising a
plurality of vector representations of non-synthetic artifacts based on a degree of similarity between (a) a vector representation of the set of model weights and (b) a corresponding vector representation of each nonsynthetic artifact in the artifact vector database; and
using the set of selected artifacts, generating a response responsive to the
query of the output generation request,
wherein the response represents a result of intent-synthesized bidirectional embedding search and is configured to be displayed on the user interface of the computing device.

2. The computer-implemented method of claim 1, further comprising:
storing the set of model weights of the linear model in a query vector database that comprises a plurality of vector representations of expected outputs of corresponding output generation requests;
receiving an indication of a modification of the artifact vector database to add a
vector representation of an additional artifact to the artifact vector database;
responsive to receiving the indication of the modification, identifying a set of
matching queries of corresponding output generation requests from the query vector database based on a degree of similarity between (a) the vector representation of the additional artifact and (b) a corresponding vector representation of each expected output in the query database;
triggering one or more programmatic workflows on the computing device using the
additional artifact.

3. The computer-implemented method of claim 2, wherein the one or more programmatic workflows includes sending a notification about relevant content within the additional artifact to one or more users identified to have initiated one or more queries within the set of matching queries.

4. The computer-implemented method of claim 1, wherein each model weight in the set of model weights of the linear model determined to correspond with the intent of the query, the set of model weights stored in a query vector database alongside the corresponding vector representation of the query and used in identifying the set of selected artifacts.

5. The computer-implemented method of claim 1, wherein the response is tagged with metadata including the corresponding vector representation and stored in the artifact vector database for matching the response to subsequent query.

6. The computer-implemented method of claim 1, wherein the first series of synthetic artifacts are identified using semantic matching of the intent of the query and the second series of synthetic artifacts are identified using syntactic matching of the intent of the query.

7. A system for generating responses using embedding searches, the system comprising:
a query processing engine configured to receive, from a user interface of a computing device, an output generation request comprising a query for generation of an output and to determine a label for the query that indicates an expected output of the output generation request;
a large language model (LLM) intent analysis module that is configured to engage a set of large language models to construct a training dataset that includes (a) a first series of synthetic artifacts with labels satisfying the label of the query, and (b) a second series of synthetic artifacts with labels failing to satisfy the label of the query;
a training module configured to use the constructed training dataset for training a linear model to determine a set of model weights of the linear model, the set of model weights used to create a vector representation of the expected output of the output generation request, the linear model trained by mapping a particular non-synthetic artifact to the first series of synthetic artifacts or the second series of synthetic artifacts; and
a database engine configured to select a set of non-synthetic artifacts from an artifact vector database based on a degree of similarity between the vector representation of the expected output and a corresponding vector representation of each non-synthetic artifact in the artifact vector database.

8. The system of claim 7, wherein the artifact vector database includes a main vector database having content and vector representations of content requested by users, and a query vector database storing vector representation of a plurality of queries initiated by the users and associated intent model weights, and the database engine selects the set of non-synthetic artifacts by matching the vector representation within the query vector database with the corresponding vector representation of the expected output of the output generation request.

9. The system of claim 7, further includes a new content processing engine that is configured to,
(a) receive an indication of a modification of the artifact vector database to add a vector representation of an additional artifact to the artifact vector database;
(b) responsive to receiving the indication, identifying a set of matching queries of corresponding output generation requests from the query vector database based on a degree of similarity between (i) the vector representation of the additional artifact and (ii) a corresponding vector representation of each expected output in the query vector database; and
(c) associate the additional artifact to the set of matching queries identified from the query vector database.

10. The system of claim 9, wherein the new content processing engine is further configured to trigger one or more programmatic workflows on the computing device using the
additional artifact, in response to receiving the indication.

11. The system of claim 7, wherein the query processing engine, the LLM intent analysis module, the training module and the database engine are implemented using one or more components of a computer system.

12. The system of claim 7, wherein the query processing engine, the LLM intent analysis module, the training module and the database engine are implemented on a terminal device or on a server or on a virtual machine or on a telecommunications network core.

13. The system of claim 7, wherein LLM intent analysis module is further configured to construct the linear model by, (a) partitioning the query into individual tokens, (b) using an embedding model to map the tokens to numerical representations of one or more corresponding embedding vectors, and (c) using attention mechanisms to assign weights to each individual token of the query.

14. The system of claim 13, wherein the LLM intent analysis module generates the embedding vectors by capturing semantic relationship of the tokens and query intent of the query.

15. The system of claim 13, wherein the LLM intent analysis module generates the embedding vectors as numerical representations based on surrounding context of each token.

16. The system of claim 13, wherein the attention mechanisms are configured to use contextual information outside of the query to assign weights to the individual tokens of the query, the contextual information providing additional context for constructing the linear model, and
wherein the contextual information is obtained from any one or a combination of user data, sessions data, and domain-specific data storing a plurality of queries initiated by the users.
